(19) United States
(12) Patent Application Publication
(10) Pub. No.: US 2010/0272520 A1
(43) Pub. Date: Oct. 28, 2010

(54) METHOD AND APPARATUS IN PNEUMATIC MATERIAL CONVEYING SYSTEM

(76) Inventor: Göran Sundholm, Tuusula (FI)

Correspondence Address: BIRCH STEWART KOLASCH & BIRCH, PO BOX 747, FALLS CHURCH, VA, 22040-0747, US

(21) Appl. No.: 12/809,184

(22) PCT Filed: Dec. 18, 2008
(86) PCT No.: PCT/FI08/50762

§ 371 Date: Jun. 18, 2010

(30) Foreign Application Priority Data
Dec. 21, 2007 (FI) 20075950
Dec. 21, 2007 (FI) 20075951
Feb. 18, 2008 (FI) 20085146

(51) Int. Cl. B65G 53/60

(52) U.S. Cl. 406/168

(57) ABSTRACT

A method for sortingly conveying materials in a pneumatic material conveying system, such as a waste conveying system, in which method, material being conveyed is fed from at least one feed point and conveyed in a conveying pipe (100) by means of a pressure difference to a reception point in which the material is separated from conveying air in a separator device (20). In the method, different material sorts are fed from one or more feed points (61A, 61B, 61C) at a time and conveyed to a reception site for at least a part of the conveying travel in the same conveying pipe and, in the method, at least a part of the conveying pipe (100) is cleaned between the conveying processes of different materials or at least when required.

### BACKGROUND OF INVENTION

The invention relates to a method according to the preamble of claim 1.

The invention also relates to an apparatus according to claim 14.

The invention relates generally to pneumatic conveying systems, such as vacuum conveying systems, particularly to collecting and conveying waste, such as conveying household waste.

Systems are known in which waste is conveyed in a piping by means of suction. In these, waste is conveyed for long distances in the piping by suction. Apparatuses are utilised, inter alia, for conveying waste in different institutions. Typical for them is that a vacuum apparatus is used for achieving a pressure difference, in which apparatus underpressure in the conveying pipe is provided with vacuum generators, such as vacuum pumps or an ejector apparatus. In the conveying pipe, there is typically at least one valve element by opening and closing of which make-up air coming in the conveying pipe is regulated. The vacuum conveying systems typically contain, inter alia, the following problems: high energy consumption, high air flow in the piping, problems with noise, dust and fine particles in the outlet pipe. Furthermore, prior-art apparatuses can have moisture problems. In rainy weather, the prior-art apparatuses can suck even e.g. 1,000 litres of water per suction from outdoor air. This causes problems with corrosion and blockages. For example, waste paper etc. sticks to the piping when moist. Furthermore, large systems have required arranging several separate make-up air valves, which increases the complexity and costs of the systems. Furthermore, the cleaning of the conveying piping is important, whereby the cleaning of a conveying system typically consisting of several separate branch pipes is awkward. Sorting of wastes is an important factor in recycling and utilisation. It sets special requirements for material conveying systems.

An object of this invention is to achieve a totally novel arrangement into connection with material conveying systems by means of which the disadvantages of known arrangements are avoided. Another object of the invention is to provide a material conveying system which enables the sorting of materials, such as wastes. An object is to provide an arrangement by means of which the sufficient cleanness of the material conveying pipe and thus its suitability for different material types being conveyed is ensured. A further object is to provide a cleaning arrangement by means of which emissions of dust and fine particles and possible odour nuisances can simultaneously be decreased. An additional object is to decrease the production of moisture in the piping.

### BRIEF DESCRIPTION OF INVENTION

The method according to the invention is mainly characterised in that, in the method, different material sorts are fed from one or more feed points at a time and conveyed to a reception site for at least a part of the conveying travel in the same conveying pipe and that, in the method, at least a part of the conveying pipe is cleaned between the conveying processes of different materials or at least when required.

In addition, the method according to the invention is characterised by what is stated in claims 2-13.

The material conveying system according to the invention is mainly characterised in that the system comprises means for feeding different material sorts from one or more feed points at a time and for conveying them to a reception site for at least a part of the conveying travel in the same conveying pipe and that the system further comprises cleaning means which are arranged to clean at least a part of the conveying pipe between the conveying processes of different materials or at least when required.

Furthermore, the material conveying system according to the invention is characterised by what is stated in claims 15-24.

The arrangement according to the invention has numerous significant advantages. By arranging the conveying piping of the system to comprise a circuit where at least part of conveying air circulates, the volume of outlet air can be decreased. At the same time, the cleaning process can be performed quickly and effectively. By arranging a feed point and a return point of the cleaning means close to each other, the cleaning process can be performed easily and effectively. The cleaning process can be easily automatised and the same cleaning means can be re-used and circulated in the system. At the same time, the energy consumption of the system is minimised. By maintaining underpressure and simultaneously blowing, it is possible to provide an effective circulation of conveying air in the circuit and conveyance of cleaning means and/or cleaning agent and/or liquid in the conveying pipe. By arranging the conveying pipe of the material conveying system to consist of operating areas i.e. partial circuits, it is possible to effectively arrange the cleaning of different parts of the piping. With the arrangement according to the invention, it is also possible to decrease the volume of outlet air substantially and simultaneously to decrease possible problems with dust and fine particles in the outlet pipe. The arrangement according to the invention also substantially decreases the noise problem caused by prior art. After cleaning, the conveying piping can be dried by circulating air in the piping. As the volume of air being sucked inside decreases, also energy consumption decreases.

### BRIEF DESCRIPTION OF FIGURES

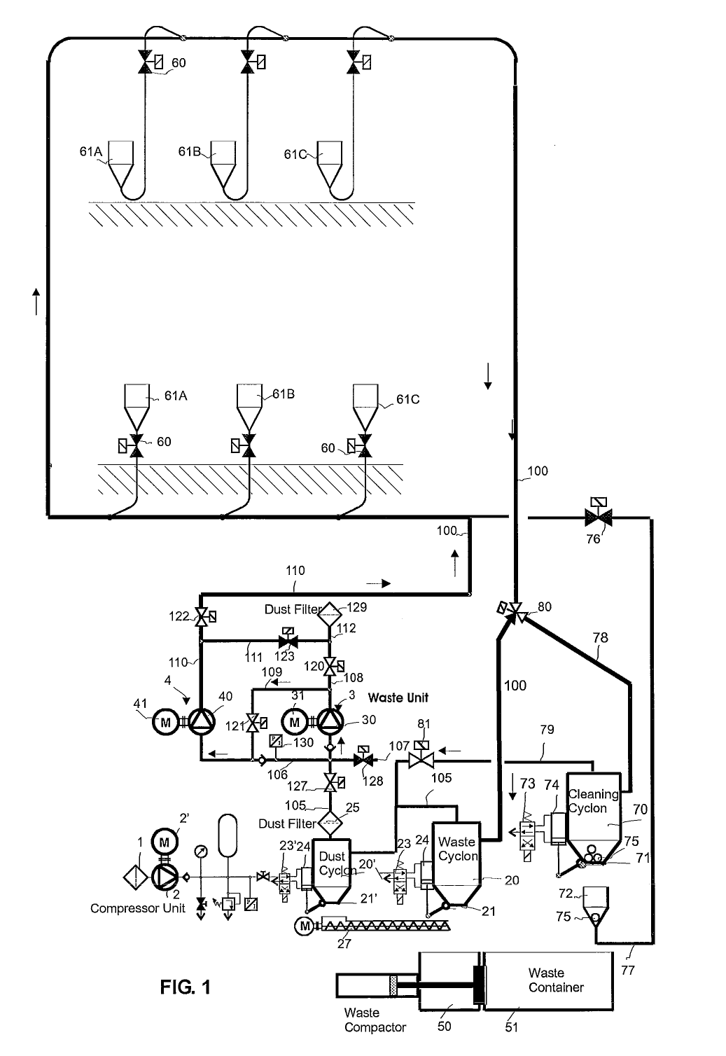

Next, the invention will be described in detail by means of an example with reference to the accompanying drawing in which FIG. 1 schematically shows a material conveying system according to the invention.

### DETAILED DESCRIPTION OF INVENTION

The FIGURE shows a simplified material conveying system, particularly a waste conveying system, which employs the method and apparatus according to the invention.

In FIG. 1, reference numbers 61A, 61B, 61C designate a feed station of materials, particularly of waste material, intended to be conveyed, from which station material, particularly waste material, such as household waste, intended to be conveyed is fed to the conveying system. The system may comprise several feed stations 61 from which the material intended to be transferred is fed to the conveying piping 100. Typically, the conveying piping comprises a main conveying pipe 100 into which several branch conveying pipes can have been connected, into which again several feed stations 61 can have been connected via feed pipes. The fed material is conveyed along the conveying piping 100 to one or more separator devices 20 in which the material being conveyed is separated, e.g. due to dropping rate and centrifugal force, from conveying air. The separated material is removed, e.g. when required, from the separator device 20 to a material container, such as a waste container 51, or to further treatment. The material container can comprise, as in the embodiment of the FIGURE, a waste compactor 50 from which the material is further conveyed to the waste container 51.

The different feed points 61A, 61B and 61C of the system are intended for different material types in the embodiment of the FIGURE. A waste treatment and conveying system can be considered as an example in which the feed point 61A is intended e.g. for mixed waste, the feed point 61B is intended e.g. for waste paper and 61C is intended e.g. for organic waste. The idea is that different types of waste are conveyed in the same conveying piping 100. Alternatively, it is also possible to use feed points 61 which are intended only for a part or for all material types being conveyed. Then, in connection with the feed point there can be arranged a selector switch or equivalent with which the type of the material being conveyed is communicated. Alternatively, it is possible to use an automatic identification of the material type or an identifier means in connection with each material portion which comprises information on the material type. The idea of the system according to the invention is that material portions of similar types are conveyed at the same time.

The invention is based on an idea in which different material types are conveyed mainly in the same main conveying pipe and in which between the conveyance of different material types or at least when required a cleaning process of the conveying pipe 100 is performed. For this, the system is provided with a cleaning apparatus.

The cleaning apparatus connected to the system comprises a cleaning separator 70 which is connectable in a circuit a section of which is formed by at least a part of the conveying piping 100. In the embodiment of the FIGURE, the cleaning separator 70 is connectable to the conveying pipe 100 in which is arranged a valve element 80, such as a three-way valve, by means of which the conveying air circulation is controlled either via the separator device 20 of material conveyance or via the cleaning separator 70. The cleaning separator 70 is connectable via an air channel 79 to an air channel 105 leading to the suction side of at least one pump device, such as a vacuum generator 3 and/or a blower 4. In the FIGURE, in the cleaning separator 70 are arranged cleaning means 75, such as cleaning balls or line pigs, which can be removed from the cleaning separator by opening an outlet hatch 71 with actuators 72, 74. The cleaning device further comprises a feed point 72 of cleaning agent and/or cleaning means which is in the embodiment of the FIGURE a funnel in which the cleaning agent and/or at least one cleaning means is settable. The feed point 72 of cleaning agent and/or cleaning means is advantageously arranged into connection with the cleaning separator 70 so that the cleaning agent and/or the cleaning means 75 are conveyable from the cleaning separator 70 to the feed point by opening the outlet hatch 71 of the cleaning separator. In the embodiment of the FIGURE, the feed point 72 is arranged below the outlet hatch of the cleaning separator whereby, by opening the outlet hatch, the cleaning agent and/or cleaning means convey to the feed point 72 of cleaning agent and/or cleaning means gravitationally. From the feed point 72 of cleaning agent and/or cleaning means, from its lower part, leads a cleaning channel 77 which is connectable in the conveying pipe 100 on its supply side. In the cleaning channel 77 is arranged a valve element 76 by means of which the connection of the cleaning channel 77 to the conveying pipe 100 can be opened or closed. When the valve 76 of the cleaning channel 77 is opened, underpressure prevailing in the piping is able to convey the cleaning agent and/or at least one cleaning means 75 from the feed funnel of the feed point 72 via the cleaning channel 77 to the conveying pipe 100. Conveying air is controlled to circulate in the circuit a section of which is formed by at least a part of the conveying pipe 100 intended to be cleaned. The cleaning agent and/or cleaning means 75 circulate in the conveying pipe 100 due to suction and/or blowing in the circuit provided by at least one pump device, such as a vacuum generator 3 and/or a blower 4, and return to the cleaning separator 70 in which the cleaning agent and/or cleaning means 75 are separated from conveying air flow, advantageously due to centrifugal force, and convey to the lower part of the cleaning separator 70. If required, the cleaning agent and/or cleaning means 75 can be replaced or cleaned and the cleaning circulation in the circuit can be repeated or next some other part of the piping can be cleaned by connecting it to the circuit. The cleaning means can also comprise e.g. grain-like material, whereby a cleaning charge typically consisting of cleaning agent, liquid and grain-like material is conveyed from the feed point 72 by means of a pressure difference in the circuit comprising the section of the conveying pipe intended to be cleaned. With the cleaning agent and/or cleaning means, the walls of the pipe being cleaned are advantageously treated mechanically and/or chemically.

In the embodiment of FIG. 1, one or more separator devices 20 are provided with material outlet elements 21, 24. From the separating device 20, a pipe 105 leads to means 3 for generating underpressure in the conveying pipe 100. In the embodiment of FIG. 1, the means for generating underpressure comprise a vacuum pump unit 3 and/or an ejector unit 4. With the means for generating underpressure, underpressure required for conveying the material is provided in the conveying piping 100. The vacuum pump unit 3 comprises a pump 30 which is operated by an actuator 31.

The system can further comprise a blower unit 4 which is connectable in the embodiment of the FIGURE from the blowing side to the conveying pipe 100 by means of a conveying air channel 110. The conveying pipe 100 is thus a section of a circuit which in the embodiment of the FIGURE consists of the main conveying pipe 100, the separator element 20, the conveying air channel 105, a possible dust separator 20′, the conveying air channel 106, and the conveying air channel 110. If the circuit circulates via the cleaning separator 70, it consists of the conveying pipe 100, the pipe 78, the cleaning separator 70, the conveying air channel 79, the conveying air channel 105, the possible dust separator 20′, the conveying air channel 106, and the conveying air channel 110.

The blower unit 4 comprises a blower 40 and its actuator 41. The blower 40 of the blower unit 4 is arranged from the suction side to the pipe 105, 106 coming from the separating device 20. The conveying pipe 100 is thus connected to the blower 40 on its blowing side. The blower also generates underpressure together with the vacuum generator.

In a section of the circuit on the suction side of the vacuum generator 3 and/or the blower 40, when travelling against the conveying direction and/or the air flow direction, which comprises in the embodiment of the FIGURE the pipes 105, 106, at least one separator device 20, 20′, 70 and a section of the main conveying pipe 100 from the separating device as far as the valves 122, underpressure prevails when the valves 122, the valves 60 of the feed stations 61A, 61B, 61C and the valve 76 of the cleaning line 77 to the conveying pipe 100 are closed.

The feed points 61A, 61B, 61C can be opened and the material conveyed to the conveying pipe stepwise, first the feed point closest in relation to the separator element 20, then the next closest etc. when feeding similar type of material.

In the upper part of the FIGURE, there are further three feed stations connected directly to the main conveying pipe via the feed pipes.

The sum of suctions provided by the vacuum unit 3 and the blower unit 4 to the conveying pipe 100, in the FIGURE from the side of the separator element, is advantageously greater than the blowing provided by the blower unit, whereby conveyance takes place in underpressure. With the blower 40, it is typically possible to provide pressure which is e.g. in the range of 0.1-0.5 bar. With the vacuum generators, it is again typically possible to provide underpressure which is e.g. in the range of 0.1-0.5 bar. According to an advantageous embodiment, the blowing stores energy (i.e. overpressure) in the section of the conveying pipe 100 between the blower 40 and the valve 122 along with the rise of pressure, when the valve 122 is closed, e.g. +0.5 bar. The suction of the vacuum unit 3 stores on the other side i.e. to the section of the valve 122 and the separator element 20 (and the pipe 105) underpressure which is e.g. −0.5 bar. When at least one of the valves 122 opens, the pressure difference can then be even 1 bar. The suction being greater than blowing, underpressure is provided in the piping, whereby waste can be sucked inside the piping from a funnel of the feed station 61.

The suction being greater than the blowing, which is the target in the system according to the invention, material fed to the conveying pipe, particularly waste material, will not be compressed and compacted, but will be able to travel “freely” in the pipe conveyed by conveying air. Then, the potential of the material being conveyed to form blockages is considerably lower than in a situation in which the blowing is greater than the suction, whereby there is a risk that the material being conveyed will accumulate and block the conveying pipe. Furthermore, underpressure decreases the power required to convey the material, because even partial underpressure in relation to the material portion being conveyed on the side of the conveying direction considerably decreases air drag, among others. In the FIGURE, arrows designate the direction of motion of air in the piping in the operating mode.

In conveying material, such as conveying waste material, when the material of the feed point is first conveyed by suction via the feed pipe to the conveying pipe, extremely fast acceleration and conveyance are provided for the material.

In the embodiment of the FIGURE, in the pipe 106 on the suction side of the blower is formed a fitting 107 in which there is a valve 128 by opening of which extra air can be brought on the suction side of the vacuum unit 4 and/or the blower 4 from outside the circuit. By opening the valve 128, it is possible to raise the pressure of air in the conveying pipe if required and an increased conveying rate is provided for conveying the material.

Into connection with each feed point 61A, 61B, 61C is arranged an outlet valve 60 which is opened and closed so that material portions of suitable size are conveyed from the feed point 61A, 61B, 61C to the conveying pipe 100. Material is fed from the feed point 61, such as the waste container, when after the container is full, the outlet valve 60 is opened either automatically or manually. Sorting according to the invention can be used as follows:

Let us assume that the feed points are to be emptied sortingly, whereby in the material conveying pipe is circulated at its simplest only one type of material portions simultaneously. Let us assume that first the feed points 61A comprising material of the first type are to be emptied. Then, underpressure is generated in the conveying pipe with the pump device, such as the vacuum unit 3 and/or the blower unit 4. In the circuit, the valve 122 is closed and the multi-way valve 80 opens a passage from the conveying pipe to the separator device 20, whereby the passage from the conveying pipe 100 to the cleaning separator 70 is closed. The feed points 61A are advantageously emptied in a sequence in which first is opened the valve 60 of the feed point 61A closest to the separator device 20 in the material travel direction, whereby a material portion in it conveys to the conveying pipe 100. Before closing the valve 60 of the first feed point 61A, the valve 60 of the next feed point 61A being next closest to the separator device 20 is opened, whereby a material portion having been in it conveys to the conveying pipe 100. The emptying of the feed points is repeated until all desired first feed points 61A have been emptied. A connection is opened from the blowing side of the pump device to the conveying pipe 100, whereby materials are conveyed from the effect of a pressure difference in the conveying pipe to the separator device 20. There can be several separator devices, e.g. one for different material types, whereby the material portion being conveyed is conveyed to a desired separator device. When the separator device becomes full or when required, it can be emptied by opening the outlet hatch 71, whereby the material conveys to the container 51.

When the cleaning means have moved in the circuit past the connecting point of the conveying pipe of the cleaning channel and/or the conveying air channel 110 coming from the pressure side of the pump device, the conveyance of the cleaning means in the circuit can be intensified by opening the valve 122, whereby there is a connection from the pressure side of the pump device, such as the blower 4 and/or the vacuum unit 3, to the conveying pipe. Then, underpressure affects the conveying pipe from the side of the cleaning separator and pressure from the pressure side of the pump device, whereby the pressure difference of conveyance is greater and a more effective conveyance of the cleaning means and/or cleaning agent is provided. At the same time, the volume of outlet air of the pump device decreases substantially, whereby possible fine-particle and odour nuisances are minimised.

In the embodiment according to the FIGURE, the cleaning apparatus is arranged into connection with an actuating unit of the material conveying system, such as in connection with a waste conveying system in a waste station or equivalent. An advantage here is that the cleaning operation can be performed and controlled in one place.

The cleaning process can be performed when required. Typically, cleaning is performed e.g. in situations in which material of different sort is fed from the material feed points. In a waste conveying system, it is possible to consider that e.g. organic waste, mixed waste and waste paper are conveyed in the material conveying pipe. Then, cleaning can be performed between the conveyance of different waste sorts.

The blowing side of the vacuum unit 3 can be connected to the air channel 110 connected on the supply side of the conveying pipe 100 and the blowing side of the blower unit 4 is connected to the air channel 110 connected on the supply side of the conveying pipe 100. The suction side of the vacuum generator is connected to the separator device 20, 70 or the air channel 105 coming from it. The suction side of the blower unit 4 is connected to the separator device 20, 70 or to the conveying air channel 105 coming from it with the air channel 106. Due to a possible requirement for extra air, there is arranged an inlet air channel 107 the valve of which is open in the embodiment of the FIGURE, whereby on the suction side of the vacuum generator 3 and/or the blower 4 is led extra air. In the operating mode of this embodiment, a maximal air flow is provided in the piping, because both the vacuum generator and the blower unit are arranged to blow in the conveying piping and suck from the conveying piping. This operating mode can be utilised for the air flushing of the conveying piping 100 and/or for the drying of the conveying piping. In the vacuum unit 3 and/or the blower unit 4, the air is compressed and heats up. This facilitates and speeds up the drying operation.

In a case according to the invention, the conveying pipe 100 is at least a section of a suction/blowing circuit, the output end and inlet end of which are advantageously arranged into connection with the waste station and in which the output end of the suction/blowing circuit is on the blowing side of the vacuum generator and/or blower 40 and the inlet end on the suction side of the vacuum generator and/or blower 40. The vacuum generator and/or blower can circulate air in the suction/blowing circuit a section of which is formed by the conveying pipe 100. The feed points 61A, 61B, 61C can be located decentralised along the system pipings distributedly. In connection with the waste conveying system, the feed points can be e.g. waste bins or waste chutes.

The invention thus relates to a method for sortingly conveying materials in a pneumatic material conveying system, such as a waste conveying system, in which method, material being conveyed is fed from at least one feed point and conveyed in a conveying pipe 100 by means of a pressure difference to a reception point in which the material is separated from conveying air in a separator device 20. In the method, different material sorts are fed from one or more feed points 61A, 61B, 61C at a time and conveyed to a reception site for at least a part of the conveying travel in the same conveying pipe and, in the method, at least a part of the conveying pipe 100 is cleaned between the conveying processes of different materials or at least when required.

According to an advantageous embodiment, in the method, at least a part of the conveying pipe 100 is connected as a section of a circuit in which conveying air is circulated at least during the conveyance of the material with at least one first pump device, such as a vacuum unit 3, and with at least one second pump device, such as a blower unit 4.

According to another embodiment, different materials are fed from separate feed points 61A, 61B, 61C and/or different materials are fed at least partly from the same feed point. Several feed points are typically arranged along the network of the material conveying system distributedly. The system can comprise both separate feed points for different materials and also feed points from which all or only a part of different materials are fed.

According to an advantageous embodiment, in the method, different material sorts are controlled to different separator devices 20 in which they are separated from conveying air. In another embodiment, different material sorts are controlled in the same separator device in which they are separated from conveying air.

According to an advantageous embodiment of the method, a valve element 60 between the material feed point 61A, 61B, 61C and the conveying pipe 100 is closed, advantageously after a certain time from opening, so that the valve 60 of the previous feed point is still open when the valve of the next feed point 61 is opened.

According to an advantageous embodiment, underpressure is provided in the conveying pipe 100 at least at the point of the feed point 61A, 61B, 61C intended to be emptied, the feed points are emptied to the conveying pipe 100 using an emptying sequence in which first is emptied a feed point 61A, 61B, 61C located closer to the separator device 20 in the material conveying direction and next a feed point 61A, 61B, 61C intended to feed similar type of material, located substantially farther from the separator device 20 in the material conveying direction.

According to an embodiment of the invention, in the method, for cleaning the conveying pipe, cleaning means 75 are fed from a feed point 72 and they return after the cleaning circulation to the separator device 20, 70 which is advantageously substantially in the same space with the feed point 72.

In an embodiment, in the method is used as the cleaning means 75 at least one cleaning ball or some other cleaning means suitable for the pipe, such as a so-called “line pig” of a pipe. According to another embodiment, as the cleaning means is used one conveying portion of material being conveyed, such as a portion of waste paper, which is controlled after the cleaning to the separator element and the material container, such as a waste container intended for mixed waste.

According to an advantageous embodiment, in the method, the cleaning means and/or cleaning agent and/or liquid is fed to the piping from the feed point 72 of cleaning means which is connected to the conveying piping with a cleaning line 77 from the effect of a pressure difference.

According to a further embodiment, the cleaning means and/or cleaning agent and/or liquid is circulated via a section of the conveying pipe 100 intended to be cleaned to the separator device 20, 70, particularly the cleaning separator 70, in which the cleaning means 75 and/or cleaning agent and/or liquid is separated from conveying air.

According to an advantageous embodiment, the cleaning means 75 and/or cleaning agent and/or liquid is controlled after the cleaning circulation, advantageously with a multi-way valve, such as a three-way valve 80, to the separate cleaning separator 70.

According to an advantageous embodiment, in the method, after the cleaning stage at least a part of the conveying piping 100 is flushed and/or dried with air by circulating conveying air in the circuit, particularly by blowing in the circuit with at least one first pump device, such as the vacuum generator 3, and/or one second pump device, such as the blower 4.

According to a yet further embodiment, the method is used in connection with a waste conveying system in which are conveyed different types of waste, such as mixed waste, waste paper or organic waste.

The invention also relates to a pneumatic material conveying system, such as a waste conveying system, which comprises at least one feed point 61 of material, particularly of waste material, a material conveying pipe 100 which is connectable to the feed point 61, a separator device 20 in which the material being conveyed is separated from conveying air, and means 3, 4 for providing a pressure difference in the conveying pipe 100 at least during the conveyance of the material. The system comprises means for feeding different material sorts from one or more feed points 61A, 61B, 61C at a time and for conveying them to a reception site for at least a part of the conveying travel in the same conveying pipe 100 and the system further comprises cleaning means which are arranged to clean at least a part of the conveying pipe 100 between the conveying processes of different materials or at least when required.

According to an advantageous embodiment, at least a part of the conveying pipe 100 is connectable as a section of a circuit in which conveying air is circulated at least during the conveyance of the material with at least one first pump device, such as a vacuum unit 3, and/or with at least one second pump device, such as a blower unit 4.

According to another advantageous embodiment, the means for generating a pressure difference comprise at least one first pump device, such as the vacuum generator 3, and/or one second pump device, such as the blower unit 4, the suction side of which is connectable to the separator element 20, particularly a cleaning separator 70, or to the conveying pipe 100 via an air channel 105, 106, 79 leading to it.

In an embodiment, the apparatus comprises means 80 for changing the travel of the conveying air circulation between two or more separator devices 20, 70.

In an advantageous embodiment, the apparatus comprises a feed point 72 of cleaning means which is connected to the conveying piping with a cleaning line 77 and in which there is a valve element 76 for opening and closing a connection from the feed point to the conveying pipe.

In an advantageous embodiment, the feed point 72 of cleaning means and the cleaning separator 70 are arranged in the vicinity of each other, advantageously substantially in the same space.

In an embodiment, the valve element 61C between the material feed point 61A, 61B, 61C and the conveying pipe 100 is arrange to close, advantageously after a certain time from opening, so that the valve 60 of the previous feed point is still open when the valve of the next feed point 61A, 61B, 61C is opened.

According to a yet further embodiment, the system is arranged to provide pressure in the circuit with at least one pump device, such as the vacuum generator 3 and/or the blower 4, the blowing side of which is connected to blow in the circuit.

In an advantageous embodiment, the apparatus also comprises means for flushing at least a part of the conveying piping 100 with air and/or for drying by circulating the conveying air in the circuit, particularly by blowing in the circuit with at least one first pump device, such as the vacuum generator 3, and/or one second pump device, such as the blower 4.

As the cleaning means 75 is arranged to be used in an embodiment a cleaning ball or some other cleaning means suitable for the conveying pipe 100, such as a so-called “line pig” of a pipe.

Advantageously, the material conveying system is a waste conveying system in which different material sorts are different types of waste, such as mixed waste, waste paper or organic waste.

It is obvious to those skilled in the art that the invention is not limited to the embodiments described above, but it may be varied within the scope of the enclosed claims. When necessary, the features possibly described in this specification together with other features may also be used separately from each other.

1. A method for sortingly conveying materials in a pneumatic material conveying system, such as a waste conveying system, in which method, material being conveyed is fed from at least one feed point and conveyed in a conveying pipe (100) by means of a pressure difference to a reception point in which the material is separated from conveying air in a separator device (20), characterised in that, in the method, different material sorts are fed from one or more feed points (61A, 61B, 61C) at a time and conveyed to a reception site for at least a part of the conveying travel in the same conveying pipe and that, in the method, between the conveying processes of different materials or at least when required at least a part of the conveying pipe (100) is cleaned.

2. A method according to claim 1, characterised in that, in the method, at least a part of the conveying pipe (100) is connected as a section of a circuit in which conveying air is circulated at least during the conveyance of the material with at least one first pump device, such as a vacuum unit (3), and/or with at least one second pump device, such as a blower unit (4).

3. A method according to claim 1, characterised in that different materials are fed from separate feed points (61A, 61B, 61C) and/or different materials are fed at least partly from the same feed point.

4. A method according to claim 1, characterised in that, in the method, different material sorts are controlled to different separator devices (20) in which they are separated from conveying air.

5. A method according to claim 1, characterised in that a valve element (60) between the material feed point (61A, 61B, 61C) and the conveying pipe (100) is closed, advantageously after a certain time after opening, so that the valve (60) of the previous feed point is still open when the valve of the next feed point (61) is opened.

6. A method according to claim 1, characterised in that underpressure is provided in the conveying pipe (100) at least at the point of the feed point (61A, 61B, 61C) intended to be emptied, the feed points are emptied in the conveying pipe (100) by using an emptying sequence in which first is emptied a feed point (61A, 61B, 61C) located closer to the separator device (20) in the material conveying direction and next a feed point (61A, 61B, 61C) intended to feed similar type of material, located substantially farther from the separator device (20) in the material conveying direction.

7. A method according to claim 1, characterised in that, in the method, for cleaning the conveying pipe, cleaning means (75) are fed from a feed point (72) and they return after the cleaning circulation to a separator device (20, 70) which is advantageously substantially in the same space with the feed point (72).

8. A method according to claim 1, characterised in that, in the method, as the cleaning means (75) is used at least one cleaning ball or some other cleaning means suitable for the pipe, such as a so-called “line pig” of a pipe.

9. A method according to claim 1, characterised in that, in the method, the cleaning means and/or cleaning agent and/or liquid is fed to the piping from the feed point (72) of cleaning means which is connected to the conveying piping with a cleaning line (77) from the effect of a pressure difference.

10. A method according to claim 1, characterised in that the cleaning means and/or cleaning agent and/or liquid is circulated via a section of the conveying pipe (100) intended to be cleaned to the separator device (20, 70), particularly a cleaning separator (70), in which the cleaning means (75) and/or cleaning agent and/or liquid is separated from conveying air.

11. A method according to claim 1, characterised in that the cleaning means (75) and/or cleaning agent and/or liquid is controlled at the end of the cleaning circulation, advantageously with a multi-way valve, such as a three-way valve (80), to the separate cleaning separator (70).

12. A method according to claim 1, characterised in that, in the method, after the cleaning stage at least a part of the conveying piping (100) is flushed and/or dried with air by circulating conveying air in the circuit, particularly by blowing in the circuit with at least one first pump device, such as the vacuum generator (3), and/or one second pump device, such as the blower (4).

13. A method according to claim 1, characterised in that the method is used in connection with a waste conveying system in which different types of waste, such as mixed waste, waste paper or organic waste, are conveyed.

14. A pneumatic material conveying system, such as a waste conveying system, which comprises at least one feed point (61) of material, particularly of waste material, a material conveying pipe (100) which is connectable to the feed point (61), a separator element (20) in which the material being conveyed is separated from conveying air, and means (3, 4) for providing a pressure difference in the conveying pipe (100) at least during the conveyance of the material, characterised in that the system comprises means for feeding different material sorts from one or more feed points (61A, 61B, 61C) at a time and for conveying them to a reception site at least a part of travel in the same conveying pipe (100) and that the system further comprises cleaning means which are arranged between different conveying processes or at least when required to clean at least a part of the conveying pipe (100).

15. A material conveying system according to claim 14, characterised in that at least a part of the conveying pipe (100) is connectable as a section of a circuit in which conveying air is circulated at least during the conveyance of the material with at least one first pump device, such as a vacuum unit (3), and/or with at least one second pump device, such as a blower unit (4).

16. A material conveying system according to claim 14, characterised in that the means for generating a pressure difference comprise at least one first pump device, such as the vacuum unit (3), and/or one second pump device, such as the blower unit (4), the suction side of which is connectable to the separator element (20), particularly a cleaning separator (70), or to the conveying pipe (100) via an air channel (105, 106, 79) leading to it.

17. A material conveying system according to claim 14, characterised in that the apparatus comprises means (80) for changing the travel of the conveying air circulation between two or more separator devices (20, 70).

18. A material conveying system according to claim 14, characterised in that the apparatus comprises a feed point (72) of cleaning means which is connected to the conveying piping with a cleaning line (77) and in which there is a valve element (76) for opening and closing a connection from the feed point to the conveying pipe.

19. A material conveying system according to claim 14, characterised in that the feed point (72) of cleaning means and the cleaning separator (70) are arranged in the vicinity of each other, advantageously substantially in the same space.

20. A material conveying system according to claim 14, characterised in that a valve element (60) between the material feed point (61A, 61B, 61C) and the conveying pipe (100) is closed, advantageously after a certain time after opening, so that the valve (60) of the previous feed point is still open when the valve of the next feed point (61A, 61B, 61C) is opened.

21. A material conveying system according to claim 14, characterised in that the system is arranged to provide pressure in the circuit with at least one pump device, such as the vacuum generator (3) and/or the blower (4), the suction side of which is connected to blow in the circuit.

22. A material conveying system according to claim 14, characterised in that the apparatus comprises means for flushing at least a part of the conveying piping (100) with air and/or drying by circulating conveying air in the circuit, particularly by blowing in the circuit with at least one first pump device, such as the vacuum generator (3), and/or one second pump device, such as the blower (4).

23. A material conveying system according to claim 14, characterised in that as the cleaning means (75) is a cleaning ball or some other cleaning means suitable for the conveying pipe (100), such as a so-called “line pig” of a pipe.

24. A material conveying system according to claim 14, characterised in that the material conveying system is a waste conveying system in which the different material sorts are different types of waste, such as mixed waste, waste paper or organic waste.
